(19) United States
(12) Patent Application Publication
(10) Pub. No.: US 2023/0368497 A1
(43) Pub. Date: Nov. 16, 2023

(54) Image Recognition Method and System of Convolutional Neural Network Based on Global Detail Supplement

(71) Applicant: Shandong Jianzhu University, Jinan (CN)

(72) Inventors: Xiaoming Xi, Jinan (CN); Chuanzhen Xu, Jinan (CN); Xiushan Nie, Jinan (CN); Guang Zhang, Jinan (CN); Xinfeng Liu, Jinan (CN)

(21) Appl. No.: 18/122,697

(22) Filed: Mar. 16, 2023

(30) Foreign Application Priority Data
May 10, 2022 (CN) 202210500255.9

(51) Int. Cl. G06V 10/77; G06V 10/82; G06V 10/42; G06V 10/764; G06V 10/774; G06V 10/80

(52) U.S. Cl. CPC G06V 10/7715; G06V 10/42; G06V 10/764; G06V 10/774; G06V 10/806; G06V 10/82

(57) ABSTRACT

An image recognition method and system of convolutional neural network based on global detail supplement, as follows: acquire the image to be recognized and then input it to trained feature extraction network for feature extraction, and obtain features of each stage; learn detail feature according to the image to be tested, and extract the detail feature map; use the self-attention mechanism to fuse the feature map and detail feature map output at the last stage to obtain global detail features; fuse the global detail feature and the features in each stage to obtain the features after global detail supplement; and classify according to the features after global detail supplement, and the category of the maximum value after calculation is the image classification result. The invention constructs a convolution neural network based on global detail supplement, and uses progressive training for image fine granularity classification, further improving fine granularity classification accuracy.

### TECHNICAL FIELD

The invention relates to the technical field related to image data processing, in particular to an image recognition method and a system of convolutional neural network based on global detail supplement, which is especially suitable for fine granularity image classification.

### BACKGROUND ART

This part only provides the background technical information related to the invention, but do not necessarily constitute the prior art.

In recent years, the classification of fine granularity images has been widely used, which has attracted the attention of many researchers. Different from traditional image recognition and classification tasks, the focus of fine granularity image classification is to further classify subcategory images falling into one category.

Traditional image classification methods can be roughly divided into the methods based on manual feature annotation and the methods based on deep learning. The methods based on manual feature annotation have limited ability to express features, and require a lot of manpower and material resources. Hence, they are not so popular. Compared with the traditional methods of manual feature annotation, the deep neural network has strong feature expression and learning ability. At present, the methods based on deep learning have become the mainstream methods of image recognition.

The inventor found that the current fine granularity image classification task is a challenge to the deep learning model. In the task of fine granularity image classification, the images of different categories have very similar appearance and features, resulting in small differences between fine granularity images of different categories. In addition, there are also interference from attitude, acquisition perspective, lighting, occlusion, background and other factors of the same category, resulting in large intra-category differences among fine granularity images of the same category. Furthermore, large intra-category difference and small inter-category difference increase the difficulty of fine granularity image classification. When extracting features, most of the existing deep learning methods focus on learning better target representation, ignoring the learning of different targets and their details, which makes it difficult to distinguish between different fine granularity images and limits the improvement of classification performance.

### CONTENT OF INVENTION

In order to solve the above problems, the invention provides an image recognition method and system of convolutional neural network based on global detail supplement, constructs the convolutional neural network based on global detail supplement, and uses progressive training for image fine granularity classification, further improving the precision of fine granularity classification.

To serve the above purpose, the invention adopts the following technical solution:

One or more embodiments provide an image recognition method of convolutional neural network based on global detail supplement, which includes the following steps:
The image to be recognized is acquired, the recognized image is input to the trained feature extraction network for feature extraction, and the features corresponding to each feature extraction stage are obtained;
Detail feature learning is carried out according to the image to be tested, and the detail feature map of the image is extracted;
The self-attention mechanism is used to fuse the feature map and detail feature map output at the last stage of the feature extraction network to obtain global detail features;
The global detail feature and the features in each stage of feature extraction are fused to obtain the features after global detail supplement;
Classification is made according to the features after global detail supplement, and the category corresponding to the maximum value in the classification calculation is the classification result of the image.

One or more embodiments provide an image recognition system of convolutional neural network based on global detail supplement, which comprises the following:
a feature extraction module, which is used to obtain the image to be recognized, input the recognized image to the trained feature extraction network for feature extraction, and obtain the features corresponding to each feature extraction stage;
a detail feature extraction module, which is used to carry out detail feature learning according to the image to be tested, and extract the detail feature map of the image;
a self-attention module, which is used to fuse the feature map and detail feature map output at the last stage of the feature extraction network with the self-attention mechanism to obtain global detail features;
a global detail supplement module, which is used to fuse the global detail features with the features in each stage of feature extraction to obtain the features after global detail supplement;
and a classification module, which is used to classify according to the features after global detail supplement, and take the category corresponding to the maximum value of classification calculation as the classification result of the image;
An electronic device which comprises a memory, a processor and a computer instruction stored in the memory and running on the processor. The steps described in the method above are completed when the computer instruction is run by the processor.

Compared with the prior art, the invention has the following advantages:

The invention obtains the detail features including the texture detail information through detail feature learning, supplements the detail features to the high-level features obtained through the feature extraction network so as to make up for the deficiency of the detail information at the high-level stage, supplements the texture detail information to the global structure features, and classifies based on the features after global detail supplement, which improves the classification effect of fine granularity images.

The advantages of the invention and additional aspects are described in detail in the following specific embodiments.

### BRIEF DESCRIPTION OF THE DRAWINGS

The drawings for specification, which form part of the invention, are intended to provide a further understanding of the invention. The schematic embodiments of the invention and their descriptions are used to explain the invention, but do not constitute any limitation of the invention.

FIG. 1 is a flowchart of the image recognition method of embodiment 1 of the invention;

FIG. 2 is a schematic diagram of the network model structure of embodiment 1 of the invention;

FIG. 3 is a flowchart of the progressive training method of feature extraction network of embodiment 1 of the invention.

### DETAILED DESCRIPTION OF THE EMBODIMENTS

The invention is further described in combination with the drawings and embodiments.

It should be noted that the following detailed descriptions are exemplary and are intended to provide a further description of the invention. Unless otherwise specified, all technical and scientific terms used herein have the same meanings as those commonly understood by ordinary technicians in the technical field to which the invention belongs.

It should be noted that the terms used here are only intended to describe the specific embodiments, but are not intended to limit the exemplary embodiments according to the invention. The singular is also intended to include the plural unless the context otherwise expressly indicates. Furthermore, it should be understood that when the terms “include” and/or “comprise” are used in this specification, they indicate the presence of features, steps, operations, devices, components and/or the combinations thereof. It also should be noted that in any case of no conflict, the embodiments and the features in the embodiments of the invention can be combined with each other. The embodiments are described in detail below in combination with the drawings.

### Embodiment 1

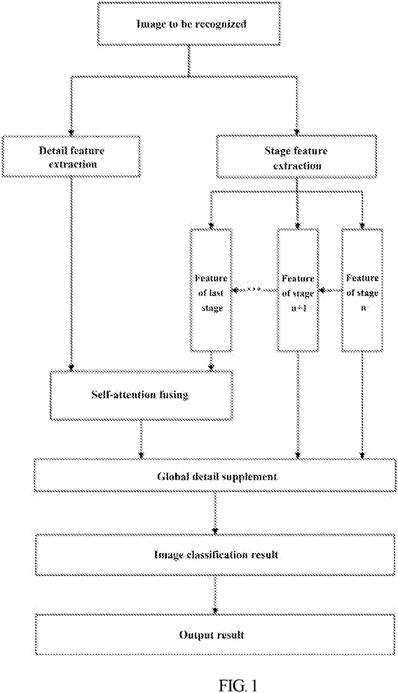

As shown in FIGS. 1 to 3, in the technical solution disclosed by one or more embodiments, the image recognition method of convolutional neural network based on global detail supplement includes the following steps:
Step 1: the image to be recognized is acquired, the recognized image is input to the trained feature extraction network for feature extraction, and the features corresponding to each feature extraction stage are obtained;
Step 2: detail feature learning is carried out according to the image to be tested, and the detail feature map of the image is extracted;
Step 3: the self-attention mechanism is used to fuse the feature map and detail feature map output at the last stage of the feature extraction network to obtain global detail features;
Step 4: the global detail feature and the features in each stage of feature extraction are fused to obtain the features after global detail supplement;
Step 5: classification is made according to the features after global detail supplement, and the category corresponding to the maximum value in the classification calculation is the classification result of the image.

Although the traditional feature extraction network can obtain the global structure features rich in semantic information, it ignores the texture detail information in the global structure. The embodiment obtains the detail features including the texture detail information through detail feature learning, supplements the detail features to the high-level features obtained through the feature extraction network so as to make up for the deficiency of the detail information at the high-level stage, supplements the texture detail information to the global structure features, and classifies based on the features after global detail supplement, which improves the classification effect of fine granularity images.

Optionally, before feature extraction, the image data is preprocessed, specifically, the image data scale is transformed into a uniform size, and part of the image data is horizontally flipped, translated and noised.

Step 1: feature extraction is carried out according to the image to be tested to obtain the feature corresponding to each feature extraction stage, and the steps are as follows:
Step 1.1: the image to be tested is extracted by multi-stage feature map, and the feature map corresponding to each stage is obtained;
The feature map can be extracted by inputting image data to the feature extraction network for the feature extraction in multiple stages.

Optionally, the feature extraction network is the convolutional neural network, which can be a deep learning network, a VGG network or a residual network. Specifically, it can be resnet18 or resnet50.

Resnet50 is described in this embodiment. Resnet50 includes five stages, each stage includes 10 layers, 50 layers in total. Each stage can output the extracted feature map.

The feature extraction network includes multiple cascaded stage networks. Each stage network includes multiple layers. Each stage network can output features corresponding to the corresponding stage. Each stage network includes a convolution layer, an activation layer and a pooling layer connected in turn. After the image data is input into the network (VGG, resnet18, resnet50, etc.), it first passes through the convolution layer, and then uses the activation function to increase nonlinearity, then enters the pooling layer for feature extraction. This process is repeated until the stage feature map is finally obtained.

Step 1.2 convolves the obtained feature map to obtain the feature vector of the corresponding feature map.

Specifically, the feature map F^{l} is input into the convolution module

$${\text{N}}_{\text{conv}}^{l} ,$$

and the feature map is converted into a feature vector

$${\text{V}}^{l} {\text{:V}}^{l} {\text{=N}}_{\text{conv}}^{l} \left({\text{F}}^{l}\right) ,$$

l∈{3,4,5} containing obvious features;
Optionally, the convolution module includes two convolution layers and one maximum pooling layer. The feature map is input into the convolution layer to further study the feature, and then the feature map obtained through two convolution layers is input into the maximum pooling layer to extract the obvious features with large feature values;
In Step 2, detail feature learning method is carried out as follows:
   For the input image to be recognized, the learning feature is first convolved, and then deconvoluted to reconstruct the input image M_{d} to obtain the reconstructed image M_{d}(I). Finally, the input image is subtracted from the reconstructed image M_{d}(I) to obtain the detailed feature map I_{d} = I - M_{d} (I)of the input image. The detailed feature map I_{d} includes the detail features of the input image texture detail information.
   Step 3: self-attention fusion: the self-attention is used to fuse the feature map F^{e} and detail feature map output at the last stage of feature extraction to obtain global detail features G_{d}; wherein, the last stage of feature extraction is the highest layer of the feature extraction network.

Specifically, the feature map _{F}e obtained from the last layer of the feature extraction network is used as the Q and K input of the self-attention S( ). The detail feature map I_{d} obtained through detail feature learning is used as the V input of the self-attention. The global feature and detail feature are fused through the self-attention to obtain the feature map G_{d} of global detail supplement;

$${G}_{d} = S \left({F}^{e} , {F}^{e} , {I}_{d}\right) ;$$

The global feature is the feature map obtained from the last layer of the feature extraction network. In this embodiment, the Q input, K input and V input of self attention are respectively _{F}e, _{F}e and I_{d}.

The global detail supplement of this embodiment is realized through detail feature learning, the feature map of the last layer of feature extraction network and self-attention fusion. The self-attention is used to fuse the feature map that can obtain the global structure with the detail feature map that contains the texture details of the input image, making up for the deficiency of detail information at the high level stage.

Step 4: the global detail features are fused with the features in each stage of feature extraction. The features in each stage of feature extraction refer to the features output in other stages except the last stage. Optionally, multi-resolution feature fusion can be used.

Specifically, the multi-resolution feature fusion method may include the following steps:
Step 4.1: the feature map of the setting layer of the feature extraction network and the feature map after global detail supplement are input into the convolution block to expand the feature map and obtain the feature vector V^{l} respectively;
Step 4.2: the feature vectors obtained are cascaded to obtain the features after global detail supplement.

Optionally, in this embodiment, the resnet50 network can be used to extract the feature maps of the reciprocal three layers of the feature extraction network, wherein the feature map of the last reciprocal layer is the feature map after global detail supplement. After being input into the convolution block to expand the feature map into feature vector V^{l}, the three groups of feature vectors are cascaded to obtain the fused feature V^{concat}.

Step 5: the fused features are input into the classification module

$${\text{C}}_{\text{class}}^{\text{concat}}$$

to obtain the category prediction results y^{concat} after fusion:

$${\text{V}}^{\text{concat}} = \text{concat} \left({\text{V}}^{l}\right) , l ∈ \left\{3 , 4 , 5\right\}$$

$${\text{y}}^{\text{concat}} = {\text{C}}_{\text{class}}^{\text{concat}} \left({\text{V}}^{\text{concat}}\right) ;$$

Optionally, the classification module includes two full connection layers and one softmax layer. The results obtained through the convolution module are processed by the classification module to obtain the classification prediction results of this stage, wherein, the category label corresponding to the maximum value y^{concat} is the classification result of the image.

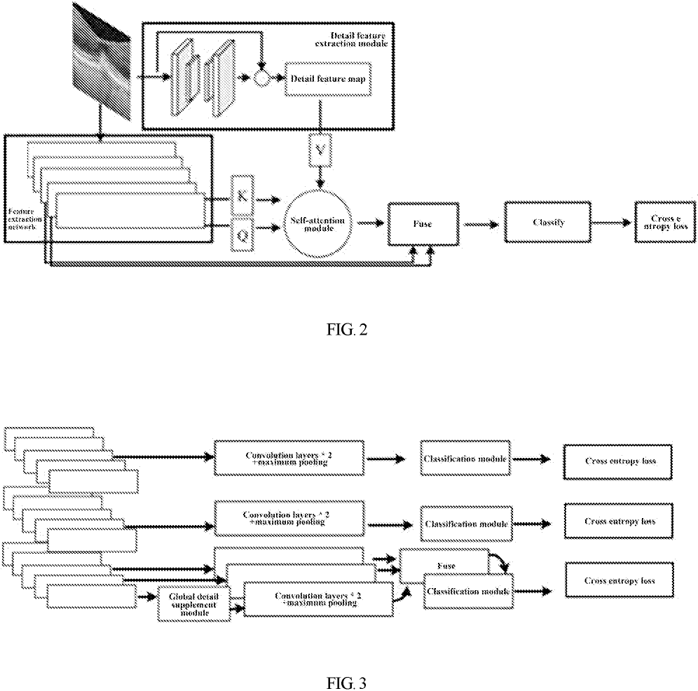

In this embodiment, the network model realizing the above steps is shown in FIG. 2, which comprises a feature extraction network, a detail feature extraction module, a self-attention module, a fusion module and a classification module, wherein the fusion module carries out global details supplement.

Progressive training is used in the feature extraction network. The training start stage n of the feature extraction network is set. From the beginning stage n to the last stage, the training is carried out by stages. From stage n+1, the training parameters obtained in the previous stage are the initial parameters until the last stage of training, so that the feature extraction network after training is obtained. As shown in FIG. 3, the specific training steps are as follows:
Step S1: the training start stage n of feature extraction network is set, and the prediction tag is obtained by classifying the output features of stage n. The loss of the real tag and the prediction tag is calculated, and it is back-propagated and continues the training until the loss becomes stable. The training parameters of the previous n stages are taken as the initial parameters of the next training stage;
Step S2: the training parameters of stage n are taken as the initial parameters, and the same training process as that of the previous stage (namely, stage n) is conducted with the output features of stage n+1. The training parameters of the previous n+1 stages are taken as the initial parameters of the next training stage, and the next training stage is carried out until the last stage of the feature extraction network;
Step S3: the training parameters of the previous stage are taken as the initial parameters, and the feature map obtained in the last stage is supplemented with global details and used as the feature of the last stage. The features from the start stage n to the last stage are cascaded to obtain the fused features. The fused features are classified to obtain classification and prediction tags, the losses of the real tag and prediction tag are calculated, the training is continued until the losses are stable, and the trained feature extraction network is obtained.

Wherein, the calculated loss of real tags and predicted tags is the cross entropy loss.

Optionally, the training is carried out from the setting start stage n of the feature extraction network training to the previous stage of the last stage. The training process of each stage is as follows:
Step S11: image data set is constructed and preprocessed;
In the training stage, image data is mainly natural image data. The original data sample may have inconsistent image size, which is not conducive to the learning of the deep network model. Therefore, the existing data sets need to be scaled to a uniform size. Finally, part of the image data is horizontally flipped, translated and noised. The data in each folder is randomly divided into sets (such as 10 sets) and combined into 10 training sets and test sets.

Step S12: the data of the dataset is input into the feature extraction network for feature extraction, and the feature map of the setting stage n is obtained;

Step S13: the obtained feature map is convolved to obtain the feature vector of the corresponding feature map.

The method of this step is the same as that of Step 1.2.

The results obtained through convolution are classified, and the classification prediction results of at this stage n are obtained;
Step S15: the stage loss is calculated. The cross entropy loss (CELoss) is calculated by using the network prediction results of stage n and the real tag. Back propagation and continuous training are carried out until the loss becomes stable. The training parameters of the first n stages are retained as the initial parameters of the next training;
Specifically, the stage network prediction results and real tags are used to calculate the cross entropy loss, and all the prediction results obtained through the l stage classification model to calculate the category corresponding to the maximum score, which is the prediction category
$${y}_{i}^{l}$$
. The cross entropy loss is calculated by using the prediction category
$${y}_{i}^{l}$$
and the real tag category yᵢ according to
$${\text{Loss}}_{c e} = \frac{1}{2} \sum {}_{i}^{n} ( - {y}_{i} l o g {y}_{i}^{l} )$$
Optionally, in the training process of the last stage, the output features of the last stage are supplemented with global details, and the global detail supplement features are fused with the features of other output stages of the feature extraction network. The fused features are classified, losses are calculated, and back propagation and continuous training are carried out until the losses become stable, and then the trained feature extraction network is obtained. The specific steps are as follows:
Step S16.1: the training parameters of the previous stage of the last stage are taken as initial parameters;
Step S16. 2: the data of the data set is input to the feature extraction network for feature extraction, and the feature map of each stage of the feature extraction network is obtained;
Step S16.3: the self-attention mechanism is used to fuse the feature map and detail feature map output at the last stage of the feature extraction network to obtain global detail features;
Step S16.4: the global detail feature vector and the feature vectors at each stage of feature extraction are fused to obtain the features after global detail supplement;
Step S16.5: classification is made according to the features after global detail supplement. The prediction category corresponding to the maximum value of the classification calculation is taken as the classification result of the image. Finally, the loss of the prediction category tag and the real category tag is calculated to obtain the final loss of the network;
Specifically, the final loss of the network is calculated by using the prediction tag y^{concat} and the real category tag y after the final fusion of the network according to
$${\text{L}}_{\text{ce}} {\text{(y}}^{\text{concat}} \text{, y) =} - \sum {}_{\text{i=1}}^{\text{m}} {\text{y}}_{\text{i}}^{\text{concat}} \times log ( {\text{y}}_{\text{i}}^{\text{concat}} ) .$$

Step S16.6: the loss after the final network fusion is taken as the final loss, and continuous training is carried out until the training rounds reach the set value. The feature extraction network corresponding to the minimum loss value is the feature extraction network after training.

Specifically, in this embodiment, the data set is input into the backbone network (resnet50 is taken as the example) to obtain the feature map of the third stage of the feature extraction network. At this stage, the feature map is expanded into the feature vector V³ which are input into the classification module to obtain prediction tags. The losses of real tags and prediction tags are calculated through the cross entropy function, and back propagation and continuous training are carried out until the loss becomes stable. The training parameters of the first three stages are reserved as the initial parameters of the next training.

The results V^{l} obtained through the convolution module are processed by the classification module C_{class} to obtain the classification prediction results of this stage according to yi =C_{class} (V^{l}), l ∈ {3, 4, 5}

The training parameters of the previous stage are taken as the initial parameters. The feature map obtained in stage 4 is expanded into the feature vector V⁴ which is input into the classification module to obtain prediction tags. The losses of real tags and prediction tags are calculated through the cross entropy function, and back propagation and continuous training are carried out until the loss becomes stable. The training parameters of the first four stages are reserved as the initial parameters of the next training.

The training parameters of the previous stage are taken as initial parameters. The feature map obtained in stage 5 is input to the global detail supplement module. After being expanded into the feature vector V^{l}, the feature map obtained is cascaded with the feature vector V³ obtained in stage 3 and the feature vector V⁴ obtained in stage 4. Then it is input into the classification module to get the prediction tag of cascade operation, the cross entropy loss is calculated, and the training is continued until the loss is stable.

This embodiment adopts a progressive training network. The improved network can improve the diversity of information acquisition, acquire the low-level subtle discriminant information, and also integrate the global structure of the target object in the high-level learning, so that the local discriminant information can be integrated with the global structure. The feature maps obtained in the last three stages of the network are processed by a convolution module and a classification module respectively, and then the CELoss of the prediction tags and actual tags obtained in this stage is calculated. In progressive training, the reciprocal stage 3 is trained at first, and then new training stages are gradually added. In each step, the obtained CELoss updates the constraint parameters. Because the receptive field at the bottom stage (such as the reciprocal stage 3 of resnet50 network) is small, the subtle discriminant information in local areas can be obtained. With the increase of stages, the global structure of the target can be obtained in the high-level stage. The progressive training method can fuse the local discriminant information with the global structure.

### Embodiment 2

Based on embodiment 1, the embodiment provides an image recognition system of convolutional neural network based on global detail supplement, which comprises the following:
a feature extraction module, which is used to obtain the image to be recognized, input the recognized image to the trained feature extraction network for feature extraction, and obtain the features corresponding to each feature extraction stage;
a detail feature extraction module, which is used to carry out detail feature learning according to the image to be tested, and extract the detail feature map of the image;
a self-attention module, which is used to fuse the feature map and detail feature map output at the last stage of the feature extraction network with the self-attention mechanism to obtain global detail features;
a global detail supplement module, which is used to fuse the global detail features with the features in each stage of feature extraction to obtain the features after global detail supplement;
and a classification module, which is used to classify according to the features after global detail supplement, and take the category corresponding to the maximum value of classification calculation as the classification result of the image;
This embodiment obtains the detail features including texture detail information through detail feature learning. The detail features are supplemented to the high-level features obtained through the feature extraction network, making up for the deficiency of detail information at the high-level stage. In addition, the invention can supplement the texture detail information to the global structure features, and classifies based on the features after global detail supplement, which improves the classification effect of fine granularity images.

It should be noted that each module in this embodiment corresponds to each step in embodiment 1, and the specific implementation process is the same, which will not be described here.

### Embodiment 3

The embodiment provides an electronic device, which comprises a memory, a processor and a computer instruction stored in the memory and running on the processor. The steps described in the method of embodiment 1 are completed when the computer instruction is run by the processor.

The above are only preferred embodiments of the invention but are not intended to limit the invention. Those skilled in the art can change or vary the invention in different ways. Any modification, equivalent replacement, improvement, etc. made within the spirit and principle of the invention shall fall within the protection scope of the invention.

Although the above content describes the specific embodiments of the invention in combination with the drawings, but it doesn’t limit the scope of protection of the invention. Those skilled in the art should understand that diversified modifications or changes can be made based on the technical solution of the invention without any creative effort, which shall fall within the scope of protection of the invention.

What is claimed is:

1. An image recognition method of convolutional neural network based on global detail supplement is characterized by including the following steps:
The image to be recognized is acquired, the recognized image is input to the trained feature extraction network for feature extraction, and the features corresponding to each feature extraction stage are obtained;
Detail feature learning is carried out according to the image to be tested, and the detail feature map of the image is extracted;
The self-attention mechanism is used to fuse the feature map and detail feature map output at the last stage of the feature extraction network to obtain global detail features;
The global detail feature and the features in each stage of feature extraction are fused to obtain the features after global detail supplement;
Classification is made according to the features after global detail supplement, and the category corresponding to the maximum value in the classification calculation is the classification result of the image;
Progressive training is used in the feature extraction network, The training start stage n of the feature extraction network is set, From the beginning stage n to the last stage, the training is carried out by stages, From stage n+1, the training parameters obtained in the previous stage are the initial parameters until the last stage of training, so that the feature extraction network after training is obtained;
The method of progressive training is adopted which comprises the following steps:
Step S1: the training start stage n of feature extraction network is set, and the prediction tag is obtained by classifying the output features of stage n, The loss of the real tag and the prediction tag is calculated, and it is back-propagated and continues the training until the loss becomes stable, The training parameters of the previous n stages are taken as the initial parameters of the next training stage;
Step S2: the training parameters of stage n are taken as the initial parameters, and the same training process as that of the previous stage is conducted with the output features of stage n+1. The training parameters of the previous n+1 stages are taken as the initial parameters of the next training stage, and the next training stage is carried out until the last stage of the feature extraction network;
Step S3: the training parameters of the previous stage are taken as the initial parameters, and the feature map obtained in the last stage is supplemented with global details and used as the feature of the last stage, The features from the start stage n to the last stage are cascaded to obtain the fused features, The fused features are classified to obtain classification and prediction tags, the losses of the real tag and prediction tag are calculated, the training is continued until the losses are stable, and the trained feature extraction network is obtained.

2. The image recognition method of convolutional neural network based on global detail supplement according to claim 1 is characterized in that before feature extraction, the image data is preprocessed, specifically, the image data scale is transformed into a uniform size, and part of the image data is horizontally flipped, translated and noised.

3. The image recognition method of convolutional neural network based on global detail supplement according to claim 1 is characterized in that feature extraction is carried out according to the image to be tested to obtain the feature corresponding to each feature extraction stage, and the steps are as follows:
The image to be tested is extracted by multi-stage feature map, and the feature map corresponding to each stage is obtained;
The obtained feature map is convolved to obtain the feature vector of the corresponding feature map.

4. The image recognition method of convolutional neural network based on global detail supplement according to claim 1 is characterized as follows:
Detail feature learning is carried out as follows: for the input image to be recognized, the learning feature is first convolved, and then deconvoluted to reconstruct the input image to obtain the reconstructed image,Finally, the input image is subtracted from the reconstructed image to obtain the detailed feature map of the input image, which includes the detail features of the input image texture detail information.

5. The image recognition method of convolutional neural network based on global detail supplement according to claim 1 is characterized in that the global detail feature and the features of each feature extraction stage are fused by using a multi-resolution feature fusion method, and the steps are as follows:
The feature map of the set level of the feature extraction network and the feature map after global detail supplement are input into the convolution block to expand the feature map and obtain the feature vector respectively;
The feature vector obtained is cascaded to obtain the feature after global detail supplement.

6. The image recognition method of convolutional neural network based on global detail supplement according to claim 1 is characterized as follows:
During the training from the setting start stage n of the feature extraction network training to the stages before the last stage, the specific steps of the training process in each stage are as follows:Image data set is constructed and preprocessed;
The preprocessed data is input to the feature extraction network for feature extraction, and the feature map of the setting stage n is obtained;
The convolution operation is carried out to obtain the feature vector of the corresponding feature map;
The results obtained through convolution are classified, and the classification prediction results of at this stage n are obtained;
The cross entropy loss is calculated by using the network prediction results of stage n and the real tag. Back propagation and continuous training are carried out until the loss becomes stable. The training parameters of the first n stages are retained as the initial parameters of the next training;
Alternatively, the training process of the last stage of the feature extraction network includes the following steps:
The training parameters of the previous stage of the last stage are taken as the initial parameters;
The data of the dataset is input into the feature extraction network for feature extraction, and the feature map of each stage of the feature extraction network is obtained;
The self-attention mechanism is used to fuse the feature map and detail feature map output at the last stage of the feature extraction network to obtain the global detail features;
The global detail feature vector and the feature vectors at each stage of feature extraction are fused to obtain the features after the global detail supplement;
The classification is based on the features after global detail supplement, The prediction category corresponding to the maximum value of the classification calculation is used as the classification result of the image, and the final loss of the prediction category label and the real category label is calculated to get the final loss of the network. The training is continued until the training round reaches the set value, The feature extraction network corresponding to the minimum loss value is the feature extraction network after training.

7. An image recognition system of convolutional neural network based on global detail supplement is characterized by comprising the following:
a feature extraction module, which is used to obtain the image to be recognized, input the recognized image to the trained feature extraction network for feature extraction, and obtain the features corresponding to each feature extraction stage;
a detail feature extraction module, which is used to carry out detail feature learning according to the image to be tested, and extract the detail feature map of the image;
a self-attention module, which is used to fuse the feature map and detail feature map output at the last stage of the feature extraction network with the self-attention mechanism to obtain global detail features;
a global detail supplement module, which is used to fuse the global detail features with the features in each stage of feature extraction to obtain the features after global detail supplement;
and a classification module, which is used to classify according to the features after global detail supplement, and take the category corresponding to the maximum value of classification calculation as the classification result of the image;
Progressive training is used in the feature extraction network, The training start stage n of the feature extraction network is set, From the beginning stage n to the last stage, the training is carried out by stages, From stage n+1, the training parameters obtained in the previous stage are the initial parameters until the last stage of training, so that the feature extraction network after training is obtained;
The method of progressive training is adopted with the following steps:
Step S1: the training start stage n of feature extraction network is set, and the prediction tag is obtained by classifying the output features of stage n, The loss of the real tag and the prediction tag is calculated, and it is back-propagated and continues the training until the loss becomes stable, The training parameters of the previous n stages are taken as the initial parameters of the next training stage;
Step S2: the training parameters of stage n are taken as the initial parameters, and the same training process as that of the previous stage is conducted with the output features of stage n+1, The training parameters of the previous n+1 stages are taken as the initial parameters of the next training stage, and the next training stage is carried out until the last stage of the feature extraction network;
Step S3: the training parameters of the previous stage are taken as the initial parameters, and the feature map obtained in the last stage is supplemented with global details and used as the feature of the last stage, The features from the start stage n to the last stage are cascaded to obtain the fused features. The fused features are classified to obtain classification and prediction tags, the losses of the real tag and prediction tag are calculated, the training is continued until the losses are stable, and the trained feature extraction network is obtained.

8. An electronic device is characterized by comprising a memory, a processor and a computer instruction stored in the memory and running on the processor, The steps described in any method of claim 1 are completed when the computer instruction is run by the processor.

9. An electronic device is characterized by comprising a memory, a processor and a computer instruction stored in the memory and running on the processor, The steps described in any method of claim 2 are completed when the computer instruction is run by the processor.

10. An electronic device is characterized by comprising a memory, a processor and a computer instruction stored in the memory and running on the processor, The steps described in any method of claim 3 are completed when the computer instruction is run by the processor.

11. An electronic device is characterized by comprising a memory, a processor and a computer instruction stored in the memory and running on the processor, The steps described in any method of claim 4 are completed when the computer instruction is run by the processor.

12. An electronic device is characterized by comprising a memory, a processor and a computer instruction stored in the memory and running on the processor, The steps described in any method of claim 5 are completed when the computer instruction is run by the processor.

13. An electronic device is characterized by comprising a memory, a processor and a computer instruction stored in the memory and running on the processor, The steps described in any method of claim 6 are completed when the computer instruction is run by the processor.
